(19) United States
(12) Patent Application Publication
(10) Pub. No.: US 2025/0088866 A1
(43) Pub. Date: Mar. 13, 2025

(54) METHOD AND APPARATUS FOR FORWARDING INFORMATION IN COMMUNICATION SYSTEM

(71) Applicant: Samsung Electronics Co., Ltd., Gyeonggi-do (KR)

(72) Inventors: Jingxing FU, Beijing (CN); Feifei SUN, Beijing (CN); Sa ZHANG, Beijing (CN)

(21) Appl. No.: 18/727,552

(22) PCT Filed: Jan. 10, 2023
(86) PCT No.: PCT/KR2023/000435

§ 371 Date: Jul. 9, 2024

(30) Foreign Application Priority Data
Jan. 11, 2022 (CN) 202210028255.3

(51) Int. Cl. H04W 16/28; H04W 56/00; H04W 72/231; H04W 74/0808

(52) U.S. Cl. CPC H04W 16/28; H04W 56/0015; H04W 72/231; H04W 74/0808

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. A method performed by a network device for forwarding information in a communication system is provided. The method includes receiving, from a base station, beam indication information indicating a first beam for receiving, by the network device, an uplink signal from a user equipment (UE) or indicating a second beam for transmitting, by the network device, a downlink signal to the UE: receiving, from a first node, a signal; and transmitting, to a second node, the signal received from the first node.

### TECHNICAL FIELD

The present disclosure relates to a technical field of communication, and in particular, the present disclosure relates to an information transmission method and a device performed by a network device for forwarding information in a communication system.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

In a wireless communication system, the transmission from a base station to a user equipment (UE) is referred to as a downlink, and the transmission from a UE to a base station is referred to as an uplink. How to improve the existing wireless communication methods so as to facilitate to meet the communication requirements is an important issue that those of ordinary skill in the art have been working on.

### Solution to Problem

In an embodiment, a method performed by a network device for forwarding information in a communication system is provided. The method includes receiving, from a base station, beam indication information indicating a first beam for receiving, by the network device, an uplink signal from a user equipment (UE) or indicating a second beam for transmitting, by the network device, a downlink signal to the UE; receiving, from a first node, a signal; and transmitting, to a second node, the signal received from the first node.

In an embodiment, a method performed by a base station in a communication system is provided. The method includes transmitting, to a network device for forwarding information, beam indication information indicating a first beam for receiving, by the network device, an uplink signal from a UE or indicating a second beam for transmitting, by the network device, a downlink signal to the UE; and receiving, from the network device, an uplink signal or transmitting, to the network device, a downlink signal.

In an embodiment, a network device for forwarding information in a communication system is provided. The network device includes a transceiver and a processor coupled with the transceiver. The processor configured to receive, from a base station via the transceiver, beam indication information indicating a first beam for receiving, by the network device, an uplink signal from a UE or indicating a second beam for transmitting, by the network device, a downlink signal to the UE, receive, from a first node via the transceiver, a signal, and transmit, to a second node via the transceiver, the signal received from the first node.

In an embodiment, a base station in a communication system is provided. The base station includes a transceiver and a processor coupled with the transceiver. The processor configured to transmit, to a network device for forwarding information via the transceiver, beam indication information indicating a first beam for receiving, by the network device, an uplink signal from a UE or indicating a second beam for transmitting, by the network device, a downlink signal to the UE, and receive, from the network device via the transceiver, an uplink signal or transmitting, to the network device, a downlink signal.

The present disclosure provides an information transmission method, an apparatus, an electronic device and a computer readable storage medium, and aims to address at least one of the technical deficiencies in the existing communication methods and to further improve the communication methods to facilitate to meet practical communication requirements. In order to achieve the objective, the technical solutions are as follows:

According to a first aspect, the present disclosure provides an information transmission method which is performed by a network device for forwarding information in a communication system, the method includes:
receiving a signal from a first node; and
transmitting the signal received from the first node, to a second node.

According to a second aspect, the present disclosure provides an information transmission method which is performed by a base station in a communication system, the method includes:
transmitting beam indication information to a network device for forwarding information in a wireless communication system, the beam indication information is configured to indicate a first beam for receiving, by the network device, a signal from a UE, or is configured to indicate a second beam for transmitting a signal received from the base station to the UE.

According to a third aspect, the present disclosure provides a network device for forwarding information in a communication system, the network device includes:
a transceiver; and
a processor coupled with the transceiver and configured to perform the operations corresponding to the information transmission method as shown in the first aspect of the present disclosure.

According to a fourth aspect, the present disclosure provides a base station in a communication system, the base station includes:
a transceiver; and
a processor coupled with the transceiver and configured to perform the operations corresponding to the information transmission method as shown in the second aspect of the present disclosure.

According to a fifth aspect, the present disclosure provides a computer readable storage medium having a computer program stored thereon, wherein, the computer program, when executed by a processor, implements the information transmission method as shown in the first aspect or the second aspect of the present disclosure.

According to a sixth aspect, the present disclosure provides a network device for forwarding information in a communication system, the network device includes:
a receiving module for receiving a signal from a first node; and
a transmitting module for transmitting the signal received from the first node, to a second node.

According to a seven aspect, the present disclosure provides a base station in a communication system, the base station includes:
a transmitting module for transmitting beam indication information to a network device for forwarding information in a wireless communication system, the beam indication information is configured to indicate a first beam for receiving, by the network device, a signal from a UE, or is configured to indicate a second beam for transmitting a signal received from the base station to the UE.

### Advantageous Effects of Invention

Embodiments of the present disclosure provide a method and an apparatus for efficiently forwarding information in a communication system.

### BRIEF DESCRIPTION OF DRAWINGS

A detailed description and discussion of one or more embodiments directed to the subject matter of the present invention is set forth to those of ordinary skill in the art in the following description, which makes reference to the accompanying drawings of the specification, wherein:

The present invention will be readily understood by the following detailed description in conjunction with the accompanying drawings, wherein like reference numerals designate like structural elements, and in which:

FIG. 1 illustrates an exemplary diagram of a wireless network according to various embodiments of the present disclosure;

FIG. 2a illustrates an exemplary diagram of a wireless transmission according to an embodiment of the present disclosure;

FIG. 2b illustrates an exemplary diagram of a reception path according to an embodiment of the present disclosure;

FIG. 3a illustrates an exemplary diagram of a UE according to an embodiment of the present disclosure;

FIG. 3b illustrates an exemplary diagram of a gNB according to an embodiment of the present disclosure;

FIG. 4 illustrates an exemplary scenario diagram according to an embodiment of the present disclosure;

FIG. 5 illustrates another exemplary scenario diagram according to an embodiment of the present disclosure;

FIG. 6 illustrates another exemplary scenario diagram according to an embodiment of the present disclosure;

FIG. 7 illustrates another exemplary scenario diagram according to an embodiment of the present disclosure;

FIG. 8 illustrates a flow diagram of an example method according to an embodiment of the present disclosure;

FIG. 9 illustrates a schematic diagram of an example of transmission periods for receiving information and/or transmitting information according to an embodiment of the present disclosure;

FIG. 10 illustrates a schematic diagram of an example of a transmission period for receiving information according to an embodiment of the present disclosure;

FIG. 11 illustrates a schematic diagram of another example of a transmission period for receiving information according to an embodiment of the present disclosure;

FIG. 12 illustrates a schematic diagram of another example of a transmission period for receiving information according to an embodiment of the present disclosure;

FIG. 13 illustrates a schematic diagram of another example of a transmission period for receiving information according to an embodiment of the present disclosure;

FIG. 14 illustrates a schematic diagram of an example of a reception beam and/or a transmission beam according to an embodiment of the present disclosure;

FIG. 15 illustrates a schematic diagram of an example of the using period of a reception beam and/or a transmission beam according to an embodiment of the present disclosure;

FIG. 16 illustrates a schematic diagram of another example of a reception beam and/or a transmission beam according to an embodiment of the present disclosure;

FIG. 17 illustrates a schematic diagram of another example of a reception beam and/or a transmission beam according to an embodiment of the present disclosure; and

FIG. 18 illustrates a structural schematic diagram of an electronic device according to an embodiment of the present disclosure.

The same or similar reference numbers and labels in the various drawings indicate the same or similar elements.

### MODE FOR THE INVENTION

Embodiments of the present disclosure are described in detail hereinafter. Examples of the embodiments are illustrated in the drawings; wherein identical or similar reference numbers indicate identical or similar elements or elements having identical or similar functions throughout. Embodiments described with reference to the accompanying drawings are exemplary, and are only for explaining the present disclosure instead of being construed as limitations to the present invention.

An ordinary person skilled in the art may understand that “a”, “an”, “said” and “this” may also refer to plural nouns, unless otherwise specifically stated. It will be further understood that the phrase “including”, when used in the description, specify the presence of stated features, integers, steps, operations, elements, and/or components and do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Further, “connection” or “coupling” used herein may include wireless connection or wireless coupling. The term “and/or” used herein includes all and any units and all the combinations of one or more of the associated listed items.

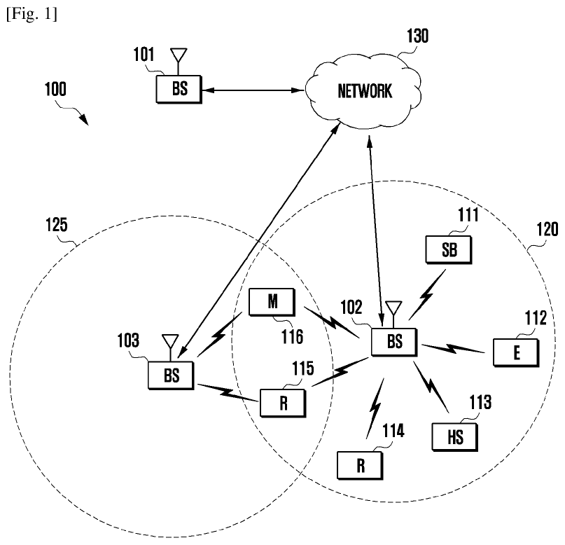

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. GNB 101 communicates with gNB 102 and gNB 103. GNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

GNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

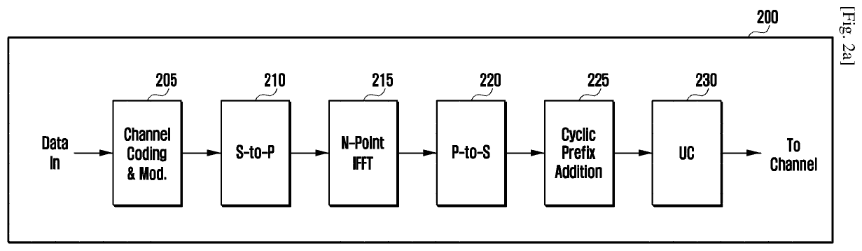

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

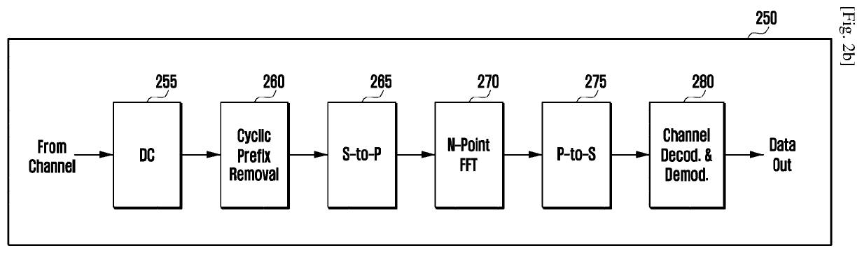

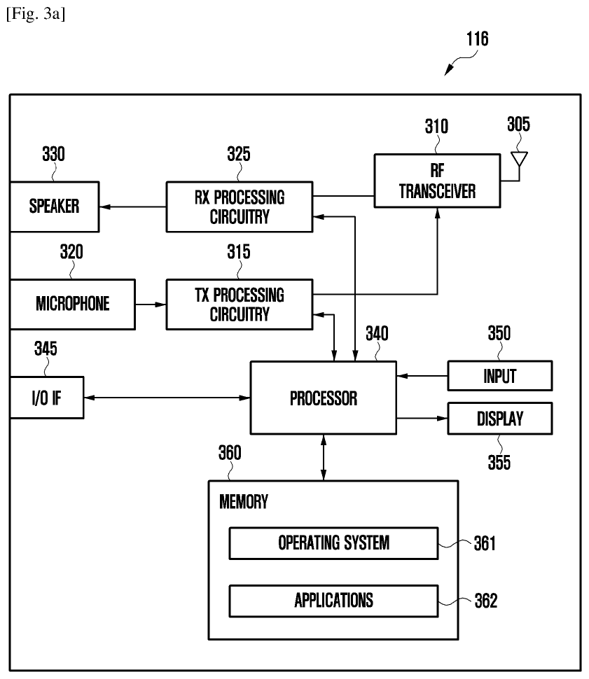

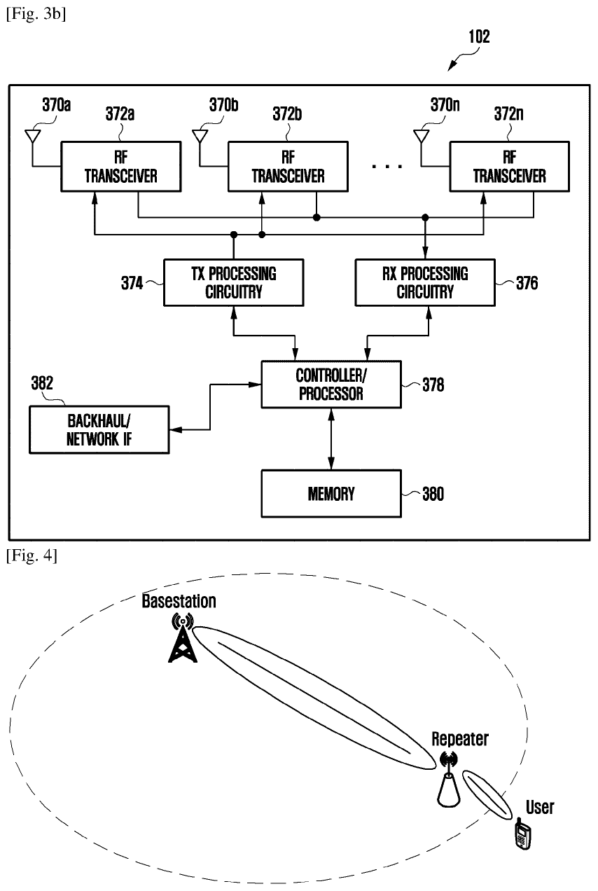

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array, gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It may be understood that the solutions provided by embodiments of the present disclosure may be applicable to, but not limited to the above wireless networks.

In the specific embodiments below, technical solutions of the present disclosure and how the above technical problems are solved by the technical solutions of the present disclosure will be explained in detail. These specific embodiments below may be combined with each other, and the same or like concepts or procedures in certain embodiments may not be repeated. Hereinafter, embodiments of the disclosure will be described with reference to the accompanying drawings. The text and accompanying drawings described as follows are provided by way of example only to aid the reader in understanding the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In order to make the objectives, technical solutions and advantages of the present disclosure clearer, the embodiments of the present disclosure will be further described in detail below in combination with the accompanying drawings.

In wireless communication networks, information from a base station to a UE and from a UE (User Equipment) to a base station (said information may include data and/or control information and/or reference signals, the control information may also be referred to as control signaling) may be forwarded by the network device in order to enhance network coverage. Wherein the name of the network device that forwards the information is not limited by embodiments of the present disclosure and may be referred to as a repeater, a smart repeater, a relay, a relaying device or other names. For case of description, an embodiment of the present disclosure is described by taking the repeater as an example.

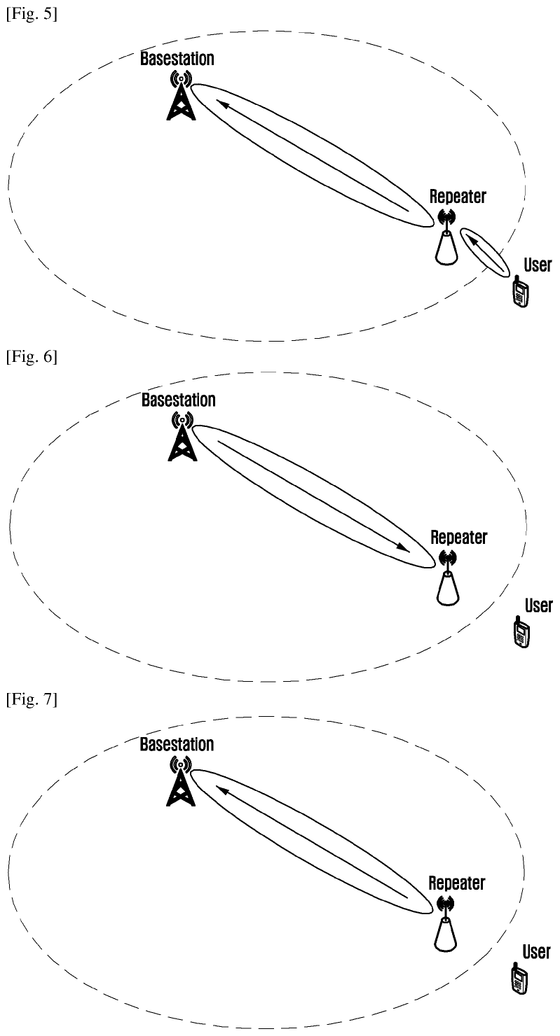

The repeater can forward information from a base station to a UE, as shown in FIG. 4, or the repeater can also forward information from a UE to a base station, as shown in FIG. 5. The repeater can also receive information transmitted by the base station without forwarding it to the UE, as shown in FIG. 6, or the repeater can also transmit information that is not transmitted by the reception UE to the base station, as shown in FIG. 7. The repeater forwarding information as described here can mean that the repeater performs direct radio frequency forwarding without information decoding, while the repeater receiving information can mean that the repeater decodes the received information.

FIG. 8 illustrates an exemplary flow chart of an information transmission method 800 according to an embodiment of the present invention. The method 800 is implemented at the repeater side.

As shown in FIG. 8, the method 800 includes:

Step S101, receiving a signal from a first node; and

Step S102, transmitting the signal received from the first node, to a second node.

That is, the repeater needs to determine whether to receive information, to transmit information, or to forward the received information. Then, the information is received, or the information is transmitted, or the received information is forwarded.

In some embodiments, the S101 may include:
receiving the signal from the first node via a first beam;
wherein the first beam is determined based on beam indication information; or
wherein the first beam is determined based on the beam indication information and information indicating a time period for performing the forwarding;
wherein the first node is a user equipment (UE), and the second node is a base station.

That is, in this embodiment, when the repeater receives signals from the UE via the first beam, the first beam is determined based on the beam indication information from the base station, or, alternatively, the first beam is determined based on the beam indication information and the information indicating the time period for performing the forwarding. If the beam indication information indicates a plurality of beams, the first beam needs to be determined in conjunction with the information indicating the time period for performing the forwarding, so that the first beam can be determined more accurately.

In some other embodiments, the S102 may include:
transmitting the signal received from the first node, to the second node via a second beam;
wherein the second beam is determined based on beam indication information; or
wherein the second beam is determined based on the beam indication information and information indicating a time period for performing the forwarding;
wherein the first node is a base station, and the second node is a user equipment (UE).

That is, in this embodiment, when the repeater forwards the received signal from the base station to the UE via the second beam, the second beam is determined based on the beam indication information from the base station, or, alternatively, the second beam is determined based on the beam indication information and the information indicating the time period for performing the forwarding. If the beam indication information indicates a plurality of beams, the second beam needs to be determined in conjunction with the information indicating the time period for performing the forwarding, so that the second beam can be determined more accurately.

In the above-described embodiments, the information indicating the time period for performing the forwarding may be used to indicate a time period for performing an uplink forwarding, and may also be used to indicate a time period for performing a downlink forwarding.

It should be noted that in various embodiments of the present disclosure, the repeater operates in a time-division multiplexing manner. That is, in a time period, the repeater receives downlink information from the base station and then the repeater forwards the received downlink information to the UE, and this time period may be referred to as a downlink forwarding period (the time period for performing a downlink forwarding as described above); in another time period, the repeater receives uplink information from the UE and then the repeater forwards the received uplink information to the base station, and this time period may be referred to as an uplink forwarding period (the time period for performing an uplink forwarding); and in still another time period, the repeater receives information transmitted by the base station without forwarding it to the UE; and in yet another time period, the repeater transmits information that is not transmitted by the reception UE to the base station.

In the example as shown in FIG. 9, the repeater receives the downlink information from the base station and transmits it to the UE during the downlink forwarding period S1, and receives the uplink information from the UE and transmits it to the base station during the uplink forwarding period S2, and receives the information transmitted by the base station without forwarding it to the UE during the downlink period S3, and transmits information that is not transmitted by the reception UE to the base station during the uplink period S4. The repeater forwards and receives information separately in a time-division manner, which can reduce the complexity of the implementation of the repeater and can avoid interference of the information forwarded by the repeater on the information that is transmitted by the base station and received by the repeater.

In order to reduce the interfere of the repeater's forwarding with the repeater's reception, the repeater receive the information without forwarding it at the same time, and different time periods can be determined for the repeater's forwarding and the repeater's reception.

In some other embodiments, the signals can be received from the UE via the first beam during a time period for performing the reception that is determined based on a first signaling.

Wherein the first signaling is system information (MIB, SIB), a higher layer signaling, a media access layer signaling, a physical layer signaling (i.e., downlink control information (DCI)) or a reference signal.

In an optional embodiment, the time period for performing the reception may be determined according to any of the following steps:
starting and ending moments for performing the reception that are configured based on the first signaling; e.g., the starting and ending moments of the signals received by the repeater from the UE are configured in the first signaling.
starting moment and duration for performing the reception that are configured based on the first signaling; e.g., the starting moment and duration of the signals received by the repeater from the UE are configured in the first signaling.
a period for performing the reception, as well as starting moment and duration for performing the reception within each period which are configured based on the first signaling. For example, a period for receiving by the repeater signals from the UE, as well as starting moment and duration for performing the reception within the period are configured in one first signaling; or, a plurality of different periods for receiving by the repeater signals from the UE, as well as starting moment and duration for performing the reception within each period are configured in a plurality of first signalings. For example, two different periods for receiving by the repeater signals from the UE, as well as starting moment and duration for performing the reception within each period are configured by two first signalings.

Alternatively, the time period for performing the reception can be preset by means of protocols.

In some other embodiments, the signals received from the base station can be transmitted to the UE via the second beam during a time period for performing the forwarding that is determined based on a second signaling.

Wherein second signaling is system information (MIB, SIB), a higher layer signaling, media access layer signaling, a physical layer signaling (i.e., downlink control information (DCI)) or a reference signal.

In an optional embodiment, the time period for performing the forwarding may be determined according to any of the following steps:
starting and ending moments for performing the forwarding that are configured based on the second signaling; e.g., the starting and ending moments of the signals received from the base station to be forwarded by the repeater to the UE are configured in the second signaling.
starting moment and duration for performing the forwarding that are configured based on the second signaling; e.g., the starting and ending moments and duration of the signals received from the base station to be forwarded by the repeater to the UE are configured in the second signaling.
a period for performing the forwarding, as well as starting moment and duration for performing the forwarding within each period which are configured based on the second signaling. For example, a period for forwarding by the repeater the signals received from the base station to the UE, as well as starting moment and duration for performing the reception within the period are configured in one second signaling; or, a plurality of different periods for receiving by the repeater signals from the UE, as well as starting moment and duration for performing the reception within each period are configured in a plurality of second signalings. For example, two different periods for forwarding by the repeater the signals received from the base station to the UE, as well as starting moment and duration for performing the reception within each period are configured by two second signalings.

In some other embodiments, the signals may be received from the UE via the first beam within a using period of the first beam that is determined based on a third signaling.

In some other embodiments, the signals received from the base station is transmitted to the UE via the second beam within a using period of the second beam that is determined based on a third signaling.

In the above-described embodiments, the using period of each beam is determined based on the periods of the first beam and/or the second beam, the number of the beams and the starting and ending moments of each beam within each period, as well as the starting moment and duration of each beam which are configured by the third signaling.

For example, the first beam for receiving by the repeater signals from the UE, and/or the a period of the second beam for forwarding the signals received from the base station to the UE, as well as the number of the beams and the starting and ending moments of each beam in the period, or the starting moment and duration of each beam are configured in one third signaling, thus the using period of each of the first beam and the second beam in the period can be determined.

Alternatively, a plurality of different periods of the first beam for receiving by the repeater signals from the UE, and/or the second beam for forwarding the signals received from the base station to the UE, as well as the number of the beams and the starting and ending moments of each beam within each period, or the starting moment and duration of each beam are configured in a plurality of third signalings. For example, two different periods for forwarding by the repeater the signals received from the base station to the UE, as well as starting moment and duration for performing the reception within each period are configured by two third signalings, thus the using period of each second beam within each period is determined.

Wherein the third signaling may be system information (including MIB and SIB), a higher layer signaling, a media access layer signaling or a physical layer signaling.

By configuring a plurality of different periods, it is thus possible to meet the first beam and/or the second beam for the repeater for different purposes.

In some other embodiments, the signal comprise synchronization signal blocks (SSBs), a set of SSB indexes to be forwarded within a period of each SSB and the second beam used for forwarding the SSB corresponding to each SSB index in the set of SSB indexes are determined according to a period and transmission time of the SSB.

It should be noted that when there are a plurality of periods for the first beam and/or the second beam, each period can be configured via one signaling; or, each period of several periods in a plurality of periods can be configured via one signaling, and the periods of other periods are determined implicitly, e.g., determined by the period of the SSB.

In some other embodiments, in order to facilitate to guarantee the performance of UE random access, the above method 800 may further include:

S103: receiving a physical random access channel (PRACH) signal from the base station via a third beam, wherein the third beam and the second beam correspond to the SSBs, and the third beam is determined based on a fourth signaling received from the base station.

Wherein the fourth signaling may be system information (including MIB and SIB), a higher layer signaling, a media access layer signaling or a physical layer signaling.

In the above various embodiments, in order to facilitate to guarantee the processing performance of the UE, an interval between the moment at which the beam indication information is received and the starting moment at which the beam indication information starts acting is greater than or equal to a minimum time interval.

In the above various embodiments, the first beam and/or the second beam are determined based on the beam indication information, which includes:
the first beam and the second beam are determined respectively based on two pieces of the beam indication information in a fifth signaling; or
the first beam is determined based on the beam indication information in the fifth signaling, and the second beam is determined based on the beam indication information in a sixth signaling.

That is, the first beam and the second beam can be indicated respectively based on two pieces of the beam indication information in one signaling, and can also be indicated respectively based on the beam indication information in two signalings, thus the first beam and the second beam can be indicated more flexibly.

In the above various embodiments, the first beam and/or the second beam are determined based on the beam indication information and information indicating the time period for performing the forwarding, which includes:

If one beam indication index value corresponding to the beam indication information corresponds to at least one first beam or at least one second beam, the beam indication index value is determined to correspond to the first beam, in a time period for performing an uplink forwarding that is determined based on the information indicating the time period for performing the forwarding; and the beam indication index value is determined to correspond to the second beam, in a time period for performing a downlink forwarding that is determined based on the information indicating the time period for performing the forwarding.

It should be noted that in this embodiment, one beam indication index may correspond to one first beam or one second beam, whether the beam indication index corresponds to the first beam or the second beam is determined in conjunction with the indication information on forwarding period; or, one beam indication index may correspond to a plurality of first beams or a plurality of second beams, whether the beam indication index corresponds to the first beams or the second beams is determined in conjunction with the indication information on forwarding period, so that at least one transmission beam and/or the at least one reception beam may be indicated simultaneously with as little signaling as possible.

An embodiment of the present invention also provides an information transmission method implemented at the base station side, in particular:
transmitting beam indication information to a network device (e.g., the repeater in the above embodiments) for forwarding information in a wireless communication system, the beam indication information is configured to indicate a first beam for receiving, by the network device, a signal from a UE, or is configured to indicate a second beam for transmitting a signal received from the base station to the UE.

That is, the base station transmits beam indication information to the repeater. The beam indication information is configured to indicate the first beam for receiving by the repeater signals from the UE, or, the beam indication information is configured to indicate the second beam for forwarding by the repeater the signals received from the base station to the UE.

In some embodiments, the method may further include:
transmitting a first signaling to the network device, wherein, the first signaling is configured to indicate a time period for performing, by the network device, the reception of the signals; e.g., the first signaling is configured to indicate a time period for performing, by the network device, the reception of the signals from the UE; or,
transmitting a second signaling to the network device, wherein, the second signaling is configured to indicate a time period for performing, by the network device, the forwarding; e.g., the second signaling is configured to indicate a time period for performing, by the network device, the forwarding of the signals to the UE, or is configured to indicate a time period for performing, by the network device, the forwarding of the signals to the base station; or
transmitting a third signaling to the network device, wherein, the third signaling is configured to indicate a using period of the first beam and/or the second beam by the network device.

In some other embodiments, the method may further include:
transmitting a fourth signaling to the network device, wherein, the fourth signaling is configured to indicate a third beam for the network device;
transmitting a physical random access channel (PRACH) signal to the network device via the third beam, wherein the third beam and the second beam correspond to synchronization signal blocks (SSBs).

In some other embodiments, transmitting the beam indication information to the network device for forwarding information in the wireless communication system includes:
transmitting a fifth signaling to the network device, two pieces of the beam indication information in the fifth signaling, which are configured to indicate the first beam and the second beam for the network device respectively; or,
transmitting the fifth signaling and a sixth signaling to the network device, wherein the beam indication information in the fifth signaling is configured to indicate the first beam for the network device, and the beam indication information in the sixth signaling is configured to indicate the second beam for the network device.

In some other embodiments, the method may further include: transmitting information indicating the time period for performing the forwarding, to the network device, wherein, the information indicating the time period for performing the forwarding is configured for the network device to determine the first beam and/or the second beam.

With the methods provided by the above various embodiments of the present disclosure, the performance of the electronic device such as the repeater and UE in receiving and transmitting information can be improved.

Hereinafter, the specific implementation processes of the information transmission method as proposed in embodiments of the present invention will be explained in detail in combination with the specific embodiments.

### Example 1

The repeater can determine the period for receiving by the repeater information from the base station by receiving the first signaling or by protocol predetermination, and receive the information transmitted by the base station in the period without forwarding information from the base station or the information from the UE.

The first signaling is system information (MIB, SIB), higher layer signaling, a media access layer signaling, a physical layer signaling (i.e., downlink control information (DCI)) or a reference signal.

The present example provides an optional implementation in which the time information on the information transmitted by the base station being received by the repeater is determined.

Optionally, starting and ending times for receiving by the repeater the information transmitted by the base station can also be determined. A method for determining starting and ending times for receiving by the repeater the information transmitted by the base station is to determine the starting time(S) and duration (T) for receiving the information transmitted by the base station. The present example provides the following optional implementations.

In an embodiment, explanations are made by taking the starting and ending times (i.e., the first signaling) for receiving the information transmitted by the base station being configured by a higher layer signaling as an example. It may be understood that it is also possible to extend the above indication approaches for the starting and ending times to application system information, media access layer signaling, physical layer signaling indication, etc.

### Implementation 1:

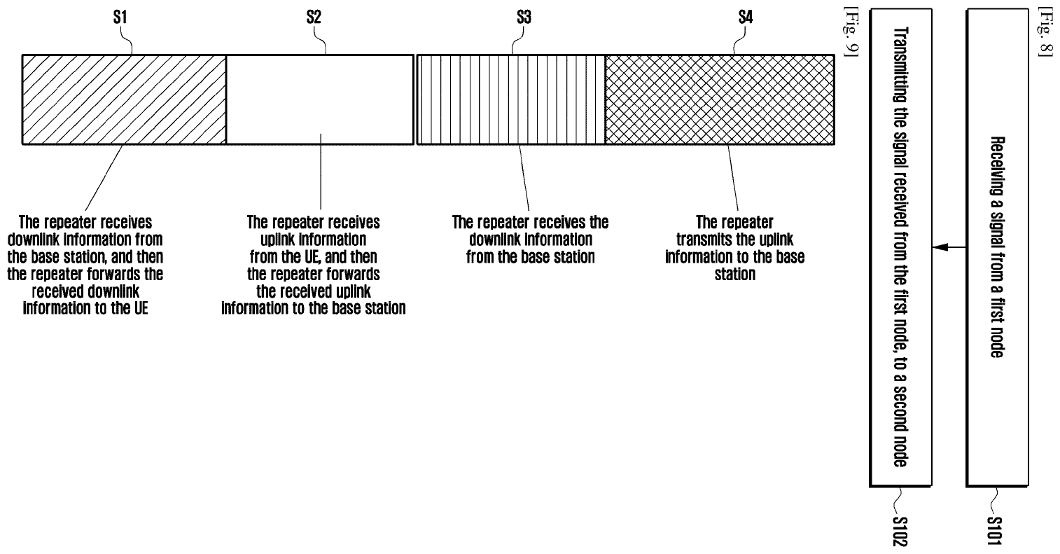

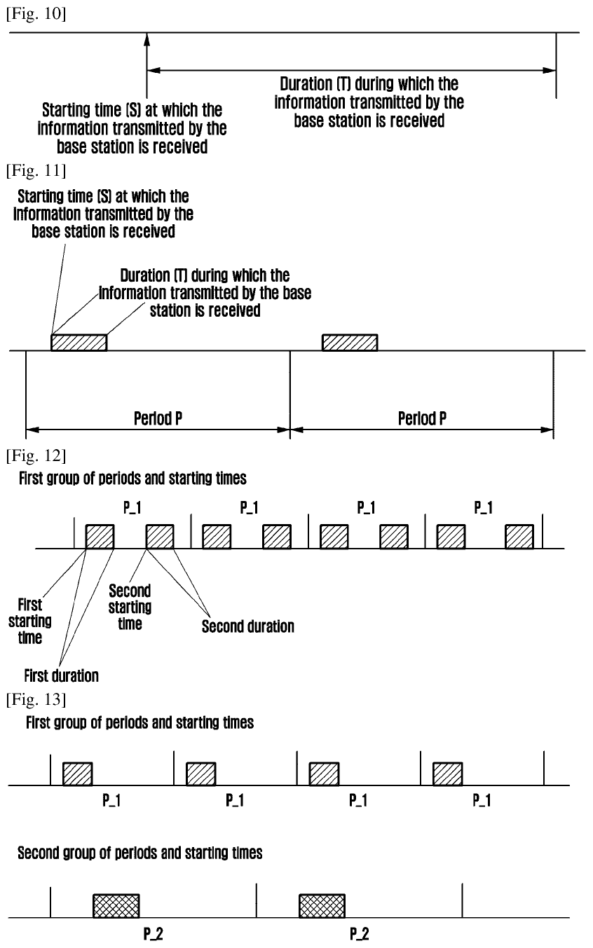

The repeater obtains the starting time(S) and duration (T) for the repeater to receive the information transmitted by the base station, by receiving higher layer signaling configurations, as shown in FIG. 10. Using this approach, the base station can adjust the time for the repeater performing receiving.

### Implementation 2:

The repeater obtains the period (P) for the repeater to receive the information transmitted by the base station, as well as the starting time(S) and duration (T) within the time of each period P, by receiving higher layer signaling configurations, as shown in FIG. 10. In addition, there may be a plurality of starting times and durations within each period. The present disclosure is explained by taking one starting time and one duration time in one period as an example, and can be extended to cases in which there are more than one starting times and more than one durations in one period, as shown in FIG. 12. Using this approach, the base station can adjust the time and frequency for the repeater performing receiving.

### Implementation 3:

The repeater obtains at least one period P_1 for the repeater to receive the information transmitted by the base station, as well as the starting time (S_i) and duration (T_i) within the time of each period P_i, by receiving at least one higher layer signaling configuration. For example, the repeater obtains periods P_1 and P_2, and the starting time (S_1) and duration (T_1) within the time of each period P_1, and the starting time (S_2) and duration (T_2) within the time of each period P_2 for receiving by the repeater the information transmitted by the base station by receiving two higher layer signaling configurations, as shown in FIG. 13. Using this approach, the base station can accommodate adjusting the time and frequency at which the repeater receives various information. For example, the first group of periods and starting times is for the repeater to receive control information (the control information may be control information indicating the beam used by the repeater to forward the information transmitted by the base station to the UE, i.e., the beam indication information as above), and the second group of periods and starting times is for the time and frequency synchronization for the repeater.

For example, the repeater obtains the period P_1 for the repeater to receive the information transmitted by the base station, as well as the starting time (S_1) and duration (T_1) within the time of period P_1, by receiving the first higher layer signaling configuration (the higher layer signaling field may be a search space).

For example, the repeater obtains the period P_2 for the repeater to receive the information transmitted by the base station, as well as the starting time (S_2) and duration (T_2) within the time of period P_2, by receiving the second higher layer signaling configuration (the higher layer signaling field may be a SSB search space configuration or CSI-RS configuration).

It should be noted that in solutions of embodiments of the present disclosure, four scenarios are involved: the repeater receives information from the base station, forwards the information received from the base station to the UE, receives information from the UE, and forwards the information received from the UE to the base station. In the above example 1, the corresponding procedure of obtaining a time period is described by only using the example of receiving by the repeater information from the base station. Since the procedure for obtaining a time period for receiving information from the UE and forwarding the information is similar as the procedure of obtaining a time period for receiving information from the base station, for brevity of description, details are not described herein again.

### Example 2

The repeater receives the beam indication information transmitted by the base station to adjust operational parameters of the repeater. For example, the repeater receives the beam indication information transmitted by the base station to adjust the transmission beam and reception beam between the repeater and the UE. Wherein the transmission beam between the repeater and the UE may be a beam for forwarding by the repeater the information received from the base station to the UE, i.e., the second beam in the above description; and the reception beam between the repeater and the UE may be a beam for receiving by the repeater information from the UE, i.e., the first beam in the above description.

The repeater needs to know a minimum time interval between the moment at which the beam indication information is received and a starting moment at which the beam indication information starts acting, as well as an ending moment at which the beam indication information stops acting. That is, the interval between the moment at which the beam indication information is received by the repeater and the starting moment at which the beam indication information starts acting needs to be greater than or equal to the minimum time interval.

The starting moment at which the beam indication information starts acting and the ending moment at which the beam indication information stops acting are explained below by taking the beam indication information being a physical layer signaling (DCI) as an example. The starting moment at which the beam indication information starts acting may be X time units after PDCCH ending OFDM symbol of the DCI of the beam indication information (the time unit may be a time slot, an OFDM symbol, and the determination of X may depend on the processing capabilities of the UE). The ending moment at which the beam indication information stops acting may be X time units after PDCCH ending OFDM symbol of the DCI of the next beam indication information (the time unit may be a time slot, an OFDM symbol). That is, the ending moment at which the previous beam indication information stops acting is the starting moment at which the next beam indication information starts acting.

### Example 3

The present example provides a solution in which a reception beam for the repeater (the first beam in the above description) and a transmission beam for the repeater (the second beam in the above description) are indicated jointly. That is, at least one beam includes at least one transmission beam for transmitting by the repeater information (data and/or control information) to the UE and/or at least one reception beam for receiving by the repeater the information transmitted by the UE. The reception beam for the repeater and the transmission beam for the repeater can be determined jointly according to the beam indication information and information for indicating a uplink forwarding period and a downlink forwarding period.

As one example, there is shown an optional form for indicating the reception beam for the repeater and the transmission beam for the repeater jointly in Table 1. As shown in Table 1, one beam indication index value corresponds to one reception beam and one transmission beam, within the duration of the beam (the using period of the beam in the above description), if the repeater receives data and control signaling, i.e., in an uplink forwarding period, the reception beam as indicated is used for reception; if the repeater transmits data and control signaling, i.e., in a downlink forwarding period, the transmission beam as indicated is used for transmission.

For example, if an indication value carried in first information is “00” and the duration of the beam is an uplink forwarding period, the repeater can receive the data and/or control signaling transmitted by the UE within the use time of the beam J1; and if an indication value carried in first information is “00” and the duration of the beam is an downlink forwarding period, the repeater can transmit data and/or control signaling to the UE using the transmission beam F2 within the use time of the beam F2.

TABLE 1
correspondence relationship between the beam indication index
value and the “transmission beam and reception beam”

| beam indication index value | transmission beam | reception beam |
|---|---|---|
| 00 | F1 | J1 |
| 01 | F2 | J2 |
| 10 | F3 | J3 |
| 11 | F4 | J4 |

Wherein whether the repeater is in an uplink forwarding period or a downlink forwarding period can be obtained by the repeater by receiving a signaling from the base station.

Using this method, the transmission beam and the reception beam can be indicated simultaneously with as little signaling as possible.

As one example, there is shown another optional form for indicating the reception beam for the repeater and the transmission beam for the repeater jointly in Table 2. As shown in Table 2, one beam indication index value corresponds to at least one reception beam and/or one transmission beam, within the duration of the one beam, if the repeater receives data and control signaling, i.e., in an uplink forwarding period, the reception beam as indicated is used for reception; if the repeater transmits data and control signaling, i.e., in a downlink forwarding period, the transmission beam as indicated is used for transmission.

TABLE 2
correspondence relationship between the beam indication index
value and the “transmission beam and reception beam”

| beam | | | | | | |
|---|---|---|---|---|---|---|
| indication | number | | starting | duration | starting | duration |
| index | of | | time of | of beam | time of | of beam |
| value | beams | beam | beam I | I | beam II | II |
| 00 | 1 | beam 1 | S11 | T11 | | |
| 01 | 2 | beam 1 and | S12 | T12 | S22 | T22 |
| | | beam 2 | | | | |
| 10 | 2 | beam 3 and | S13 | T13 | S23 | T23 |
| | | beam 4 | | | | |
| 11 | 3 | beam 2 and | S14 | T14 | S24 | T24 |
| | | beam 3 | | | | |

For example, an indication value carried in first information is “01”, the indication value “01” corresponds to beam 1 and beam 2, the starting time of the beam 1 is S12, the duration thereof is T12, the starting time of the beam 2 is S22, and the duration of the beam 2 is T22. The duration of the beam 1 is an uplink forwarding period, the repeater can receive data and/or control signaling transmitted by the UE within the use time of the beam 1; and the duration of the beam 2 is a downlink forwarding period, the repeater can transmit data and/or control signaling to the UE using the transmission beam 2 within the use time of the beam 2.

Using this method, a plurality of transmission beams and a plurality of reception beams can be indicated simultaneously with as little signaling as possible.

Another implementation method may be to determine at least one reception beam for the repeater and/or a transmission beam for the repeater according to the beam indication information.

As one example, there is shown yet another optional form for indicating the reception beam for the repeater and the transmission beam for the repeater jointly in Table 3. As shown in Table 3, one beam indication index value corresponds to at least one reception beam and/or one transmission beam.

TABLE 3
correspondence relationship between the beam indication index
value and the “transmission beam and reception beam”

| beam | | | | | | |
|---|---|---|---|---|---|---|
| indication | number | | starting | duration | starting | duration |
| index | of | | time of | of beam | time of | of beam |
| value | beams | beam | beam I | I | beam II | II |
| 00 | 1 | beam I: transmission | S11 | T11 | | |
| | | beam 1 | | | | |
| 01 | 2 | beam I: transmission | S12 | T12 | S22 | T22 |
| | | beam 1 | | | | |
| | | beam II: transmission | | | | |
| | | beam 2 | | | | |
| 10 | 2 | beam I: transmission | S13 | T13 | S23 | T23 |
| | | beam 2 | | | | |
| | | beam II: reception | | | | |
| | | beam 3 | | | | |
| 11 | 2 | beam I: reception | S14 | T14 | S24 | T24 |
| | | beam 1 | | | | |
| | | beam II: reception | | | | |
| | | beam 3 | | | | |

For example, an indication value carried in first information is “01”, the indication value “01” corresponds to two beams, i.e., beam I and beam II respectively, wherein the beam I is the transmission beam 1, the beam II is the transmission beam 2, the starting time of the beam I is S12, the duration thereof is T12, the starting time of the beam II is S22, and the duration of the beam 2 is T22. If an indication value carried in first information is “10”, the indication value “10” corresponds to two beams, i.e., beam I and beam II respectively, wherein the beam I is the transmission beam 2, the beam II is the reception beam 3, the starting time of the beam I is S13, the duration thereof is T13, the starting time of the beam II is S23, and the duration of the beam 2 is T23.

Using this method, a plurality of transmission beams and a plurality of reception beams can be indicated simultaneously with as little signaling as possible.

Using the solutions provided in embodiments of the present disclosure, the performance of information transmission (including transmission and reception) in a communication system can be improved effectively.

In another optional solution, the reception beam for the repeater and the transmission beam for the repeater may also be indicated separately, i.e., the beam for transmitting information and the beam for receiving information may be indicated separately.

A method in which the reception beam for the repeater and the transmission beam for the repeater are indicated separately is to provide in one DCI two beam indication fields, i.e., field a and field b respectively, the field a is configured to indicate the reception beam for the repeater, and the field b is configured to indicate the transmission beam for the repeater.

Another method in which the reception beam for the repeater and the transmission beam for the repeater are indicated separately is to use the beam indication information in one DCI to indicate the reception beam for the repeater, and to use another beam indication information b in another DCI to indicate the transmission beam for the repeater.

Using this method, the transmission beam and/or the reception beam can be indicated more flexibly.

### Example 4

In the present example, the repeater can determine the transmission beam for transmitting by the repeater information to the UE and/or the reception beam for receiving by the repeater the information transmitted by the UE by receiving a third signaling transmitted by the base station. The transmission beam for transmitting by the repeater information to the UE and/or the reception beam for receiving by the repeater the information transmitted by the UE can also be determined via an implicit signaling. For example, the repeater can determine the transmission beam for transmitting by the repeater information to the UE and/or the reception beam for receiving by the repeater the information transmitted by the UE by receiving the period and time of the SSB that are transmitted by the base station.

Wherein the third signaling may be system information (including MIB and SIB), a higher layer signaling, a media access layer signaling or a physical layer signaling.

The beams indicated by the third signaling can be used periodically; optionally, the number of beams within each period may be the same, the starting and ending times of the beams within each period may be the same, and the beams are identical at the same time position within each period. For example, the period of a beam is P, there are S beams being transmitted in each period P (i.e., the number of the second beams is S). The S beams can be transmitted continuously, the total duration of the S beams is T, and the duration of each beam in S beams may be T1, T2, . . . , T3. Of course, the S beams can also be discontinuous, and the starting time and duration of each beam can be indicated by a second signaling.

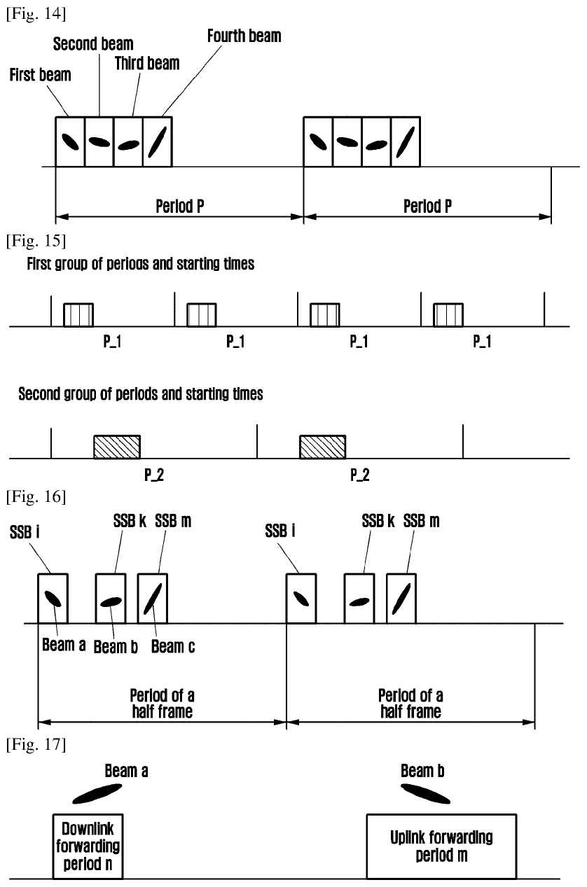

In an example as shown in FIG. 14, S is 4, that is, the number of at least one second beam is 4, i.e., the first beam to the fourth beam respectively as shown in FIG. 14, and the use times of these four beams are continuous. Optionally, the third signaling may contain indication information on the four beams, information on the starting time of the first beam in these four beams, and duration of each of these four beams. If the durations of these four beams are all the same, the third signaling can also contain indication information on the starting time of the first beam and the total duration of these four beams. The repeater can determine which four beams are these four beams specifically and the time information on each beam according to the third signaling, and receive the information corresponding to each beam or send the information corresponding to each beam out via the beam within the use time of the beam.

The benefit of using this method is that a measurement signal (configuration information) is provided for measuring the transmission performance of each beam by the UE, and then the measurement result is fed back to the base station, the measurement result may serve as basis for the base station determining the beam for the repeater.

The repeater obtains at least one period P_i of the transmission beam for transmitting by the repeater information to the UE and/or the reception beam for receiving by the repeater the information transmitted by the UE, as well as the starting time (S_i) and duration (T_i) within each period by receiving at least one third signaling. For example, the repeater obtains the periods P_1 and P_2 of the transmission beam for transmitting by the repeater information to the UE and/or the reception beam for receiving by the repeater the information transmitted by the UE, as well as the starting time (S_1) and duration (T_1) within the time of each period P_1 and the starting time (S_2) and duration (T_2) within the time of each period P_2 by receiving two higher layer signaling configurations, as shown in FIG. 15. The number of beams and the beams within each period P_1 and the number of beams and the beams within each period P_2 may be determined separately.

Using this method, the base station can fulfill the transmission beam for transmitting by the repeater information to the UE and the reception beam for receiving by the repeater the information transmitted by the UE for different purposes. For example, the first group of periods and starting times is the transmission beam for transmitting by the repeater information to the UE and/or the reception beam for receiving by the repeater the information transmitted by the UE to facilitate the UE to perform channel measurement; the second group of periods and starting times is the transmission beam for transmitting by the repeater information to the UE and the reception beam for receiving by the repeater the information transmitted by the UE for the random access of the UE.

By receiving SSBs (SS/PBCH blocks) and the information in MIB or SIB, from the base station, the repeater obtains the period of the half frames with SS/PBCH blocks, of the SSBs that are transmitted by the base station, as well as a beams configured for the repeater to forward the SSBs to the UE within a period of each SSB. A set of SSB indexes which may be forwarded by the repeater to the UE within one SSB period, as well as the beam for forwarding a SSB corresponding to each SSB index of the SSB indexes in the set, can be obtained via protocol predetermination, information in MIB or SIB, and an implicit signaling. For example, the SSB received by the repeater is a SSB corresponding to a SSB index of i, by receiving SIB, it is derived that the SSBs to be forwarded by the repeater are {the SSB corresponding to a SSB index of i, a SSB corresponding to a SSB index of k, and a SSB corresponding to a SSB index of m}; and a beam a is used by the repeater to forward the SSB corresponding to the SSB index of i, a beam b is used by the repeater to forward the SSB corresponding to the SSB index of k, and a beam c is used by the repeater to forward the SSB corresponding to the SSB index of m, as shown in FIG. 16.

### Example 5

The present example provides a solution for indicating the paring of the reception beam for the repeater and the transmission beam for the repeater.

The repeater receives a fourth signaling transmitted by the base station, e.g., system information (including MIB and SIB), a higher layer signaling, a media access layer signaling or a physical layer signaling, to determine a transmission beam a for one downlink forwarding period n of the repeater (the second beam in the above description) and a reception beam b for one uplink forwarding period m (the third beam in the above description) is determined accordingly, as shown in FIG. 17.

For example, by receiving SSBs (SS/PBCH blocks) and the information in MIB or SIB, from the base station, the repeater obtains the period of the half frames with SS/PBCH blocks, of the SSBs that are transmitted by the base station, as well as a beams configured for the repeater to forward the SSBs to the UE within a period of each SSB. A set of SSB indexes which may be forwarded by the repeater to the UE within one SSB period, as well as the beam for forwarding a SSB corresponding to each SSB index of the SSB indexes in the set, can be obtained via protocol predetermination, information in MIB or SIB, and an implicit signaling. For example, the SSB received by the repeater is a SSB corresponding to a SSB index of i, by receiving SIB, it is derived that the SSBs to be forwarded by the repeater are {the SSB corresponding to a SSB index of i, a SSB corresponding to a SSB index of k, and a SSB corresponding to a SSB index of m}; and a beam a is used by the repeater to forward the SSB corresponding to the SSB index of i, a beam b is used by the repeater to forward the SSB corresponding to the SSB index of k, and a beam c is used by the repeater to forward the SSB corresponding to the SSB index of m. With respect to a SSB i corresponding to a SSB index i, a transmission beam a for the downlink forwarding period n is determined. The repeater uses the reception beam b for uplink forwarding period m that is paired with the transmission beam a for the downlink forwarding period n to receive the information transmitted by the UE within the time period of the random access channel occasion (RO) corresponding to the SSB index i.

Using this method, the performance of random access of the UE may be facilitate to be guaranteed.

Based on the principles identical to those of methods provided by the embodiments of the present disclosure, an embodiment of the present disclosure also provides a network device for forwarding information in a communication system, the network device may include a receiving module and a first transmitting module, wherein:
a receiving module for receiving a signal from a first node; and
a first transmitting module for transmitting the signal received from the first node, to a second node.

In some embodiments, the receiving module is specifically configured for:
receiving the signal from the first node via a first beam;
wherein the first beam is determined based on beam indication information; or
wherein the first beam is determined based on the beam indication information and information indicating a time period for performing the forwarding;
wherein the first node is a user equipment (UE), and the second node is a base station.

In one embodiment, the receive module, when receiving the signal from the first node via a first beam, is specifically configured for: receiving the signal from the UE during a time period for performing the reception that is determined based on a first signaling.

In some optional embodiments, the time period for performing the reception is determined according to any of the following steps:
starting and ending moments for performing the reception that are configured based on the first signaling;
starting moment and duration for performing the reception that are configured based on the first signaling; and
a period for performing the reception, as well as starting moment and duration for performing the reception within each period which are configured based on the first signaling.

In some other embodiments, the first transmitting module is specifically configured for:
transmitting the signal received from the first node, to the second node via a second beam;
wherein the second beam is determined based on beam indication information; or
wherein the second beam is determined based on the beam indication information and information indicating a time period for performing the forwarding;
wherein the first node is a base station, and the second node is a user equipment (UE).

In one embodiment, the first transmitting module, when transmitting the signal received from the base station to the UE via the second beam, is specifically configured for: transmitting the signal received from the base station to the UE via the second beam during a time period for performing the forwarding that is determined based on a second signaling.

In some optional embodiments, the time period for performing the forwarding is determined according to any of the following steps:
starting and ending moments for performing the forwarding that are configured based on the second signaling;
starting moment and duration for performing the forwarding that are configured based on the second signaling; and
a period for performing the forwarding, as well as starting moment and duration for performing the forwarding within each period which are configured based on the second signaling.

In the above-described embodiments, the beam indication information is received from the base station.

In some other embodiments, the receiving module is specifically configured for; receiving the signal from the UE via the first beam within a using period of the first beam that is determined based on a third signaling.

In some other embodiments, the first transmitting module is specifically configured for: transmitting the signal received from the base station to the UE via the second beam within a using period of the second beam that is determined based on a third signaling.

In the above-described embodiments, the using period of each beam is determined based on the periods of the first beam and/or the second beam, the number of the beams and the starting and ending moments of each beam within each period, as well as the starting moment and duration of each beam which are configured by the third signaling.

In some other embodiments, the signal comprise synchronization signal blocks (SSBs), a set of SSB indexes to be forwarded within a period of each SSB and the second beam used for forwarding the SSB corresponding to each SSB index in the set of SSB indexes are determined according to a period and transmission time of the SSB.

In some other embodiments, the receiving module is further configured for receiving a physical random access channel (PRACH) signal from the base station via a third beam, wherein the third beam and the second beam correspond to the SSBs, and the third beam is determined based on a fourth signaling received from the base station.

In some other embodiments, an interval between the moment at which the beam indication information is received and the starting moment at which the beam indication information starts acting is greater than or equal to a minimum time interval.

In some other embodiments, the first beam and/or the second beam are determined based on the beam indication information, which includes:
the first beam and the second beam are determined respectively based on two pieces of the beam indication information in a fifth signaling; or
the first beam is determined based on the beam indication information in the fifth signaling, and the second beam is determined based on the beam indication information in a sixth signaling.

In some other embodiments, the first beam and/or the second beam are determined based on the beam indication information and information indicating the time period for performing the forwarding, which includes:

If one beam indication index value corresponding to the beam indication information corresponds to at least one first beam or at least one second beam, the beam indication index value is determined to correspond to the first beam, in a time period for performing an uplink forwarding that is determined based on the information indicating the time period for performing the forwarding; and the beam indication index value is determined to correspond to the second beam, in a time period for performing a downlink forwarding that is determined based on the information indicating the time period for performing the forwarding.

Based on the principles identical to those of methods provided by the embodiments of the present disclosure, an embodiment of the present disclosure also provides a base station device which may include a second transmitting module, the second transmitting module is configured for transmitting beam indication information to a network device for forwarding information in a wireless communication system, the beam indication information is configured to indicate a first beam for receiving, by the network device, a signal from a UE, or is configured to indicate a second beam for transmitting a signal received from the base station to the UE.

In some embodiments, the second transmitting module is further configured for:
transmitting a first signaling to the network device, wherein, the first signaling is configured to indicate a time period for performing, by the network device, the reception of the signals from the UE; or,
transmitting a second signaling to the network device, wherein, the second signaling is configured to indicate a time period for performing, by the network device, the forwarding; or,
transmitting a third signaling to the network device, wherein, the third signaling is configured to indicate a using period of the first beam and/or the second beam by the network device.

In some other embodiments, the second transmitting module is further configured for:
transmitting a fourth signaling to the network device, wherein, the fourth signaling is configured to indicate a third beam for the network device;
transmitting a physical random access channel (PRACH) signal to the network device via the third beam, wherein the third beam and the second beam correspond to synchronization signal blocks (SSBs).

In some other embodiments, the second transmitting module, when transmitting beam indication information to a network device for forwarding information in a wireless communication system, is specifically configured for:
transmitting a fifth signaling to the network device, two pieces of the beam indication information in the fifth signaling, which are configured to indicate the first beam and the second beam for the network device respectively; or,
transmitting the fifth signaling and a sixth signaling to the network device, wherein the beam indication information in the fifth signaling is configured to indicate the first beam for the network device, and the beam indication information in the sixth signaling is configured to indicate the second beam for the network device.

In some other embodiments, the second transmitting module is further configured for:
transmitting information indicating the time period for performing the forwarding, to the network device, wherein, the information indicating the time period for performing the forwarding is configured for the network device to determine the first beam and/or the second beam.

Based on the principles identical to those of methods provided by the embodiments of the present disclosure, an embodiment of the present disclosure provides an electronic device, the electronic device includes: a transceiver; and a processor coupled with the transceiver and configured to implement the methods provided in any optional embodiments in present application.

Optionally, the electronic device may be implemented as the network device for forwarding information as described above, e.g., a repeater. The network device includes a transceiver; and a processor coupled with the transceiver and configured to perform the methods performed by the network device for forwarding information which are provided in any optional embodiments in present application. Optionally, the electronic device may be implemented as a base station, the base station includes a transceiver; and a processor coupled with the transceiver and configured to perform the methods performed by the base station which are provided in any optional cmbodiments in present application.

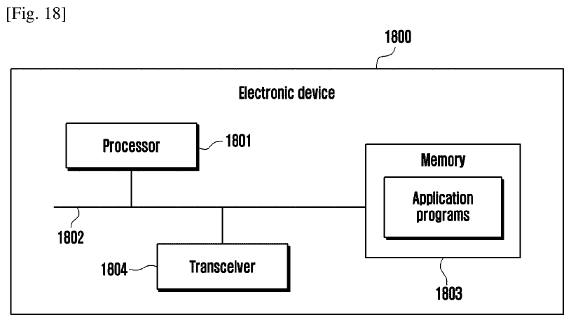

FIG. 18 illustrates a structural schematic diagram of an electronic device provided in an optional embodiment of the present disclosure, as shown in FIG. 18. The electronic device 1800 shown in FIG. 18 includes a processor 1801 and a memory 1803. Wherein, the processor 1801 is connected with the memory 1803, for example, through the bus 1802. Optionally, the electronic device 1800 may further include a transceiver 1804, and the transceiver 1804 may be used for data interaction between the electronic device and other electronic devices, such as data transmission and/or data reception and so on. It should be noted that, in practical applications, the transceiver 1804 is not limited to one, and the structure of the electronic device 1800 does not constitute a limitation to the embodiments of the present disclosure.

The processor 1801 may be a central processing unit (CPU), a general-purpose processor, a digital signal processor (DSP), an application-specific integrated circuit (ASIC), a field programmable gate array (FPGA) or other programmable logic devices, transistor logic devices, hardware components, or any combination thereof. It may implement or execute the various exemplary logical blocks, modules and circuits described in connection with this disclosure. The processor 1801 may also be a combination for realizing computing functions, such as a combination including one or more microprocessors, a combination of a DSP and a microprocessor, and so on.

The bus 1802 may include a path to transfer information between the components described above. The bus 1802 may be a peripheral component interconnect (PCI) bus or an extended industry standard architecture (EISA) bus and so on. The bus 1802 may be divided into an address bus, a data bus, a control bus, and so on. For case of presentation, only one thick line is shown in FIG. 18, but it does not mean that there is only one bus or one type of bus.

The memory 1803 may be a Read Only Memory (ROM) or other types of static storage devices that may store static information and instructions, a Random Access Memory (RAM) or other types of dynamic storage devices that may store information and instructions, it may also be electrically erasable and programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage media inclusion or, other magnetic storage devices, or any other medium capable of carrying or storing desired program codes having forms of instructions or data and capable of being access by a computer. However, it is not limited thereto.

The memory 1803 is used for storing application program codes (computer programs) for executing the solution of the present disclosure, and the execution is controlled by the processor 1801. The processor 1801 is configured to execute application program codes stored in the memory 1803 to implement the content shown in the foregoing method embodiments.

It should be understood that, although various steps in the flowcharts of the drawings are shown in sequence as indicated by arrows, these steps are not necessary to be executed in sequence according to the sequence indicated by arrows. Unless explicitly stated herein, there are no strict limitations on the sequence of execution for those steps, and those steps may be executed in other orders. Also, at least part of the steps in the flowcharts of the drawings may include a plurality of sub-steps or a plurality of stages, and these sub-steps or stages are not necessary to be executed and finished at the same moments but may be executed at different moments. The execution order of these sub-steps or stages is not necessarily to be performed in sequence but may be executed by turns or alternately with other steps or the sub-steps of other steps or at least part of the stages.

The foregoing are only some implementations of the present invention, it should be noted that, for a person of ordinary skill in the art, several improvements and modifications may be made without departing from the principles of the present invention, and these improvements and modifications should also be regarded as the scope of the present invention.

1. A method performed by a network device for forwarding information in a communication system, the method comprising:
receiving, from a base station, beam indication information indicating a first beam for receiving, by the network device, an uplink signal from a user equipment (UE) or indicating a second beam for transmitting, by the network device, a downlink signal to the UE;
receiving, from a first node, a signal; and
transmitting, to a second node, the signal received from the first node.

2. The method of claim 1, wherein the receiving of the signal further comprises:
receiving, from the first node, the signal using a first beam,
wherein the first beam is determined based on the beam indication information or determined based on the beam indication information and information indicating a time period for forwarding the signal, and
wherein the first node is the UE, and the second node is the base station.

3. The method of claim 1, wherein the transmitting of the signal further comprises:
transmitting, to the second node, the signal received from the first node using a second beam,
wherein the second beam is determined based on the beam indication information or determined based on the beam indication information and information indicating a time period for forwarding the signal, and
wherein the first node is the base station, and the second node is the UE.

4. The method of claim 2, wherein the receiving of the signal using the first beam further comprises:
receiving, from the UE, the signal using the first beam during a time period determined based on a first signaling from the base station.

5. The method of claim 3, wherein the transmitting of the signal received using the second beam further comprises:
transmitting, to the UE, the signal received from the base station using the second beam during a time period based on a second signaling from the base station.

6. A method performed by a base station in a communication system, the method comprising:
transmitting, to a network device for forwarding information, beam indication information indicating a first beam for receiving, by the network device, an uplink signal from a user equipment (UE) or indicating a second beam for transmitting, by the network device, a downlink signal to the UE; and
receiving, from the network device, an uplink signal or transmitting, to the network device, a downlink signal.

7. The method of claim 6, further comprising:
transmitting, to the network device, a first signaling indicating a time period for receiving, by the network device, the uplink signal from the UE or the downlink signal from the base station;
transmitting, to the network device, a second signaling indicating a time period for forwarding, by the network device, the uplink signal or the downlink signal; or
transmitting, to the network device, a third signaling indicating a using period of the at least one of the first beam or the second beam by the network device.

8. The method of claim 6, further comprising:
transmitting information indicating a time period for forwarding, by the network device, the uplink signal or the downlink signal,
wherein the information is used for the network device to determine at least one of the first beam or the second beam.

9. A network device for forwarding information in a communication system, the network device comprising:
a transceiver; and
a processor coupled with the transceiver and configured to:
receive, from a base station via the transceiver, beam indication information indicating a first beam for receiving, by the network device, an uplink signal from a user equipment (UE) or indicating a second beam for transmitting, by the network device, a downlink signal to the UE,
receive, from a first node via the transceiver, a signal, and
transmit, to a second node via the transceiver, the signal received from the first node.

10. The network device of claim 9, wherein the processor is further configured to receive, from the first node via the transceiver, the signal using a first beam,
wherein the first beam is determined based on the beam indication information or determined based on the beam indication information and information indicating a time period for forwarding the signal, and
wherein the first node is the UE, and the second node is the base station.

11. The network device of claim 9, wherein the processor is further configured to transmit, to the second node via the transceiver, the signal received from the first node using a second beam,
wherein the second beam is determined based on the beam indication information or determined based on the beam indication information and information indicating a time period for forwarding the signal, and
wherein the first node is the base station, and the second node is the UE.

12. The network device of claim 10, wherein the processor is further configured to receive, from the UE via the transceiver, the signal using the first beam during a time period determined based on a first signaling from the base station.

13. The network device of claim 11, wherein the processor is further configured to transmit, to the UE via the transceiver, the signal received from the base station using the second beam during a time period based on a second signaling from the base station.

14. A base station in a communication system, the base station comprising:
a transceiver; and
a processor coupled with the transceiver and configured to:
transmit, to a network device for forwarding information via the transceiver, beam indication information indicating a first beam for receiving, by the network device, an uplink signal from a user equipment (UE) or indicating a second beam for transmitting, by the network device, a downlink signal to the UE, and
receive, from the network device via the transceiver, an uplink signal or transmitting, to the network device, a downlink signal.

15. The base station of claim 14, wherein the processor is further configured to:
transmit, to the network device via the transceiver, a first signaling indicating a time period for receiving, by the network device, the uplink signal from the UE or the downlink signal from the base station,
transmit, to the network device via the transceiver, a second signaling indicating a time period for forwarding, by the network device, the uplink signal or the downlink signal, or
transmit, to the network device via the transceiver, a third signaling indicating a using period of the at least one of the first beam or the second beam by the network device.
